(19) United States
(12) Patent Application Publication
(10) Pub. No.: US 2008/0030796 A1
(43) Pub. Date: Feb. 7, 2008

(54) APPARATUS AND METHOD OF STACKING SHEETS AND IMAGE FORMING APPARATUS

(75) Inventor: Kazutaka SAKAMOTO, FUKUOKA (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/833,205

(22) Filed: Aug. 2, 2007

(30) Foreign Application Priority Data
Aug. 7, 2006 (JP) 2006-214118

(51) Int. Cl. H04N 1/04

(52) U.S. Cl. 358/444; 271/3.13; 358/296

(57) ABSTRACT

The image forming apparatus of the invention has: a supplying portion on which sheet-like information recording media each having a wireless tag are to be stacked, and from which the information recording media are sequentially sent out from a top; a reading portion which reads information stored in the wireless tag on the information recording medium that is supplied from the supplying portion; an image erasing portion which erases an image on the information recording medium sent from the reading portion; an image forming portion which forms an image on the information recording medium sent from the erasing portion; and a stacking portion on which information recording media that have undergone the image formation are stacked from a bottom in a sequence at which the information recording media are sent from the image forming portion.

### BACKGROUND OF THE INVENTION

1. Field of the Invention

The present invention relates to an apparatus and method of stacking one by one sheets serving as information recording media, and an image forming apparatus which continuously performs image formation on the sheets.

2. Description of the Related Art

Conventionally, an RFID (Radio Frequency IDentification) system in which an RFID tag is used is put into practical use in a system using a frequency band of, for example, 13.56 MHz such as a logistics system, an air cargo management system, an automatic ticket gate system, a room entrance/exit management system, or a traffic system. The RFID system comprises an RFID tag having an IC chip and an antenna coil, and a reading/writing apparatus which communicates with the RFID tag. The reading/writing apparatus has a loop antenna.

RFID tags have various configurations and are used in various usage manners. When RFID tags are stuck to or included in various information recording media, RFID tags can be used in a wide variety of RFID systems. In such an RFID system, an electric power and transmission data are transmitted always or intermittently from the loop antenna, and reception data are obtained from an RFID tag which is in a range where the electric power and the transmission data can be received.

Examples of a system in which the RFID system is employed, and an information recording medium which is used in the system will be described. In the case where the RFID system is used in a logistics system or an air cargo management system, examples of the information recording medium are a management form, a delivery form, and a luggage tag having an RFID tag. In the case where the RFID system is used in an automatic ticket gate system, the information recording medium is a ticket or a season ticket having an RFID tag. In the case of a room entrance/exit management system, the information recording medium is an ID card. A season ticket, ID card, or the like which is used for personal authentication is also called a non-contact IC card system.

In such an RFID system, information recorded in an IC chip of an RFID tag is often image-formed as visible information on the surface of an information recording medium having an RFID tag. The image formation on an information recording medium can be performed by a method in which information is printed on the surface of the information recording medium by various printing means such as ink jet, thermal transfer, and a laser beam printer, or the write-once image forming method in which a thermal coloring layer is previously formed in the surface of the information recording medium, and thermal recording is conducted.

In the write-once image forming method, a large amount of information cannot be displayed because of restrictions on the printing region on the surface of an information recording medium. Therefore, also an image forming method in which rewriting is enabled is employed. For example, a method in which a liquid crystal display member is formed in an information recording medium, or that in which display is performed by using a thermally reversible material in which repeated printing and erasure are enabled by heating is employed. For example, Patent Reference 1 (JP-A-2001-240218) discloses an air cargo management system in which air cargoes are automatically sorted, dispatched, and received with using a non-contact IC tag (RFID tag) and an IC baggage tag (information recording medium) having a rewritable displaying portion configured by a thermally reversible material. Patent Reference 2 (JP-A-2001-243502) discloses an airline ticketing system which uses a non-contact IC tag (RFID tag) and an airline ticket (information recording medium) having a rewritable displaying portion.

An image forming apparatus which forms and erases an image on an information recording medium having a wireless communication medium such as the RFID tag is disclosed in, for example, Patent Reference 3 (JP-A-2005-297442) and Patent Reference 4 (JP-A-2005-179020). In these image forming apparatuses, information recording media in each of which an image is formed on the upper face are stacked on a sheet supply tray, the information recording media stacked on the sheet supply tray are supplied one by one from the top, the image on the information recording medium is erased, and then a new image is formed. Thereafter, the information recording medium on which the image has been formed is discharged onto a sheet discharge tray.

In the image forming apparatus disclosed in Patent Reference 3, information recording media stacked on the sheet supply tray are supplied one by one from the top, an image is formed on the upper face of the information recording medium, and the medium then discharged onto the sheet discharge tray while maintaining the state where the image-formed face is directed upward. By contrast, in the image forming apparatus disclosed in Patent Reference 4, information recording media stacked on the sheet supply tray are supplied one by one from the top, an image is formed on the lower face of the information recording medium, and the information recording medium is reversed so that the image-formed face is directed upward, and then discharged onto the sheet discharge tray.

Namely, the image forming apparatuses have the property that the stacking sequence of the information recording media stacked on the sheet supply tray, and that of the information recording media discharged onto the sheet discharge tray are inevitably inverted to each other. In the case of information recording media having RFID tags which are repeatedly used, therefore, the sequence of the information recording media discharged onto the sheet discharge tray must be reversed. The operation of reversing the sequence is performed by hand, or by a dedicated apparatus which is separately provided. The operation of reversing the sequence is a significant factor in the cost increase in the case where the information recording media are repeatedly used.

### SUMMARY OF THE INVENTION

In the invention, the image forming apparatus comprises: a supplying portion on which sheet-like information recording media each having a wireless tag are to be stacked, and from which the information recording media are sequentially sent out from a top; a reading portion which reads information stored in the wireless tag on the information recording medium that is supplied from the supplying portion; an image erasing portion which erases an image on the information recording medium sent from the reading portion; an image forming portion which forms an image on the information recording medium sent from the erasing portion; and a stacking portion on which information recording media that have undergone the image formation are stacked from a bottom in a sequence at which the information recording media are sent from the image forming portion.

In the invention, the sheet stacking apparatus which stacks sheets comprises: comprises: two rotating members which rotate in different directions about rotation axes that horizontally extend in parallel to each other, respectively; a projection which is projectingly disposed on a side face of each of the rotating members, and with being separated from the rotation axis of the rotating member; a sheet inserting portion which inserts each of the sheets; and a driving portion which rotates the rotating members about the rotation axes, in the rotating members, levels of the projections during rotation are substantially identical with each other, and a distance between the rotating members is set so that a distance between the projections is larger and smaller than a width of the sheet, the apparatus further comprises a controlling portion controlling in a following manner, after the sheet is inserted by the sheet inserting portion to a predetermined position under the projections, the rotating members are rotated in directions in which the projections push up the sheet from a lower side in a state where the distance between the projections is smaller than the width of the sheet, when the projections reach a predetermined level, another one of the sheets is subsequently inserted by the sheet inserting portion to the predetermined position under the projections, and the rotating members are further rotated in the same directions to attain a state where the distance between the projections is larger than the width of the sheet, thereby causing the sheet to be stacked on the subsequently inserted sheet.

In the invention, the sheet stacking method is a method wherein, in a sheet stacking apparatus which stacks sheets, wherein the apparatus comprises: two rotating members which rotate in different directions about rotation axes that horizontally extend in parallel to each other, respectively; a projection which is projectingly disposed on a side face of each of the rotating members, and with being separated from the rotation axis of the rotating member; a sheet inserting portion which inserts each of the sheets; and a driving portion which rotates the rotating members about the rotation axes, in the rotating members, levels of the projections during rotation are substantially identical with each other, and a distance between the rotating members is set so that a distance between the projections is larger and smaller than a width of the sheet, (i) after the sheet is inserted by the sheet inserting portion to a predetermined position under the projections, the rotating members are rotated in directions in which the projections push up the sheet from a lower side in a state where the distance between the projections is smaller than the width of the sheet, (ii) when the projections reach a predetermined level, another one of the sheets is subsequently inserted by the sheet inserting portion to the predetermined position under the projections, and (iii) the rotating members are further rotated in the same directions to attain a state where the distance between the projections is larger than the width of the sheet, thereby causing the sheet to be stacked on the subsequently inserted sheet.

It is an object of the invention to provide a sheet stacking apparatus and method which stack sheet-like information recording media having a wireless tag while maintaining the stacking sequence, and an image forming apparatus in which maintenance is easily performed, and a wireless tag for a sheet-like information recording medium is less damaged.

### BRIEF EXPLANATION OF THE DRAWINGS

FIG. 1 is a schematic longitudinal section view of an image forming apparatus of an embodiment of the invention;

FIG. 2 is a functional block diagram of the image forming apparatus of the embodiment of the invention;

FIGS. 3A and 3B are respectively plan and bottom views showing a rewritable sheet which is to be processed by the image forming apparatus of the embodiment of the invention;

FIG. 4 is a detailed longitudinal section view of a stacking portion of the image forming apparatus of the embodiment of the invention;

FIGS. 5A and 5B are longitudinal section views showing a disassembled state of the stacking portion of the image forming apparatus of the embodiment of the invention;

FIG. 6 is a plan view, partially omitted, of the stacking portion of the image forming apparatus of the embodiment of the invention;

FIGS. 7A and 7B are respectively plan and longitudinal section views, partially omitted, illustrating the operation of the stacking portion of the image forming apparatus of the embodiment of the invention;

FIGS. 8A and 8B are respectively plan and longitudinal section views, partially omitted, illustrating the operation of the stacking portion of the image forming apparatus of the embodiment of the invention;

FIGS. 9A and 9B are respectively plan and longitudinal section views, partially omitted, illustrating the operation of the stacking portion of the image forming apparatus of the embodiment of the invention;

FIGS. 10A and 10B are respectively plan and longitudinal section views, partially omitted, illustrating the operation of the stacking portion of the image forming apparatus of the embodiment of the invention;

FIGS. 11A and 11B are respectively plan and longitudinal section views, partially omitted, illustrating the operation of the stacking portion of the image forming apparatus of the embodiment of the invention;

FIGS. 12A and 12B are longitudinal section views respectively showing maximum and minimum sheet dimensions in an operation of sliding a holding frame of the image forming apparatus of the embodiment of the invention; and

FIG. 13 is a flowchart showing the operation of the image forming apparatus of the embodiment of the invention.

### DETAILED DESCRIPTION OF THE PREFERRED EMBODIMENT OF THE INVENTION

Hereinafter, an embodiment of the invention will be described with reference to the accompanying drawings.

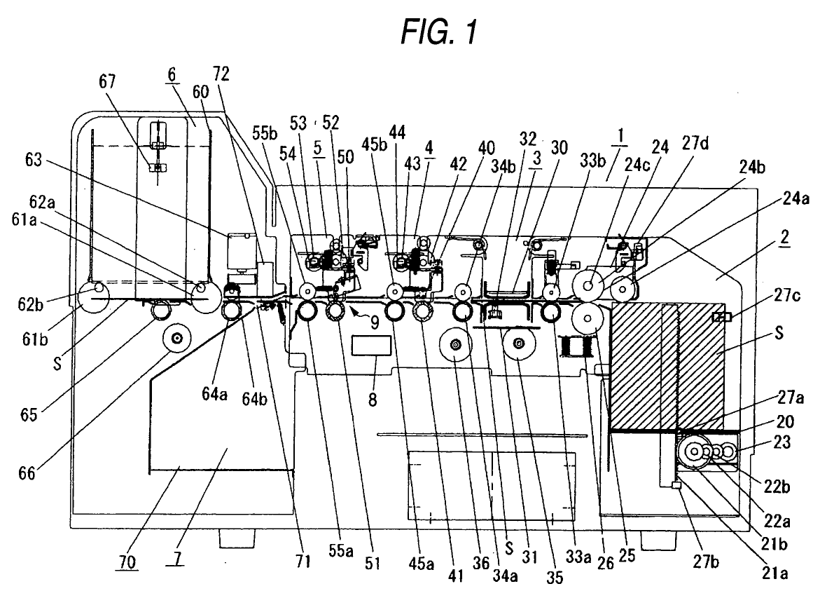

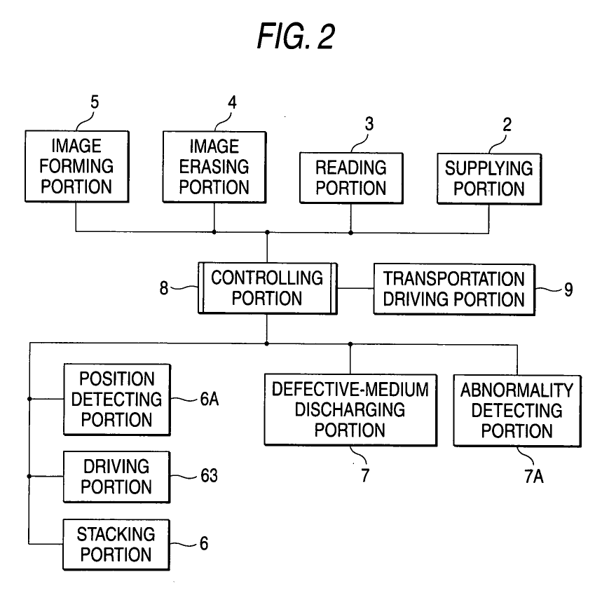

FIG. 1 is a schematic longitudinal section view of an image forming apparatus of an embodiment of the invention, and FIG. 2 is a functional block diagram showing functions of portions of the image forming apparatus of the embodiment of the invention.

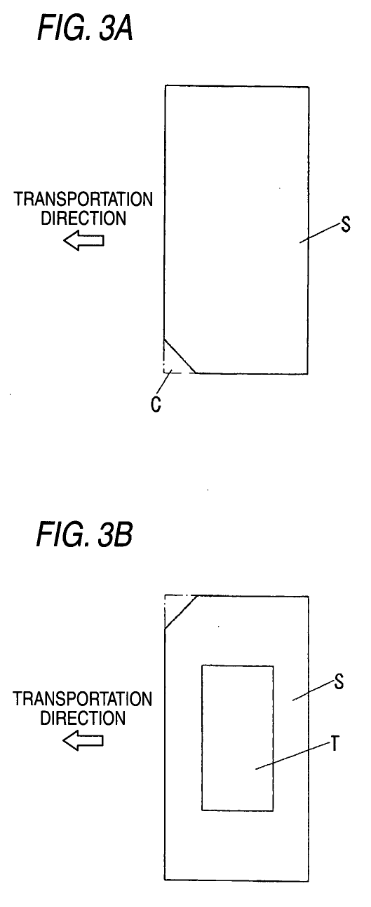

FIGS. 3A and 3B are respectively plan and bottom views showing a rewritable sheet which is to be processed by the image forming apparatus of FIG. 1.

Referring to FIGS. 1 and 2, the image forming apparatus 1 of the embodiment of the invention has: a recording medium supplying portion 2 where rewritable sheets (hereinafter, referred to as “sheets”) S serving as information recording media on which an image is rewritable are stacked, and the sheets S are sequentially supplied from the top; a wireless communication medium processing portion (reading portion) 3 which communicates with an RFID tag (wireless tag) T (see FIG. 3B) serving as a wireless communication medium that is disposed on each sheet S supplied from the recording medium supplying portion 2, and which reads and writes information; an image erasing portion 4 which erases an image recorded on the sheet S; an image forming portion 5 which forms an image on the sheet S; a stacking portion 6 on which the sheets S that have undergone the image formation are stacked; and a defective-medium discharging portion 7 which discharges a sheet S that has been determined defective.

Referring to FIGS. 1 and 2, the image forming apparatus 1 further comprises a controlling portion 8 which controls the supplying portion 2, the reading portion 3, the erasing portion 4, the image forming portion 5, the stacking portion 6, the defective-medium discharging portion 7, and the like. The image forming apparatus 1 further comprises a transportation driving portion 9 (including the transporting mechanism) for moving the information recording medium to a predetermined stacking position of the stacking portion 6 through a path which extends substantially horizontally from the supplying portion 2 to the reading portion 3, the image erasing portion 4, the image forming portion 5, and the stacking portion 6.

Further referring to FIGS. 1 and 2, the image forming apparatus 1 has an abnormality detecting portion 7A which, for example, detects whether the sheet (recording medium) S is correctly directed or not, and detects whether information of the wireless tag on the sheet is normally read or not. The abnormality detecting portion 7A corresponds to a sheet direction sensor 22 and an RFID control board 31 shown in FIG. 2. If the abnormality detecting portion 7A detects an abnormality, a sheet which is deemed abnormal is transported to the defective-medium discharging portion 7 (this will be described later in detail). The operations of the following portions are implemented by the controlling portion 8.

Hereinafter, the above-mentioned portions will be described in detail. Referring to FIG. 1, the recording medium supplying portion 2 comprises: a sheet table 20 on which plural sheets S are to be stacked; a lifting rack 21a which lifts and lowers the sheet table 20; a lifting gear 21b which is rotatably fixed to the sheet table 20, and which meshes with the lifting rack 21a; a lifting motor 23 which rotates the lifting gear 21b via gears 22a, 22b; and sheet intake rollers 24a, 24b and separation roller 25 which are used for introducing one by one the sheets S on the sheet table 20. The sheet intake rollers 24a, 24b are configured as a sheet intake roller unit 24 which swings about a rotation support shaft 24c of the sheet intake roller 24b. The separation roller 25 is pressed by a spring 26 toward the sheet intake roller 24b.

In the recording medium supplying portion 2, disposed are: a sheet detection sensor 27a which detects the sheet S on the sheet table 20; a sheet table home position sensor 27b which detects the lower limit position (in the embodiment, the initial position) of the sheet table 20; a sheet table near-end sensor 27c which detects proximity to the upper limit position of the sheet table 20; and an intake roller unit position sensor 27d which detects that the sheet intake roller unit 24 is located at the intake position of the sheet S.

The wireless communication medium processing portion 3 comprises: an RFID antenna board 30 which communicates with the RFID tag disposed on the sheet S; the RFID control board 31 which is connected to the RFID antenna board 30, and which reads and writes information of the RFID tag; a sheet direction detection sensor 32 which detects whether the sheet S is transported in the correct direction; driving rollers 33a, 34a which transport the sheet S or not; a cleaning roller 33b which is placed opposedly to the driving roller 33a to clean the sheet S and function as a driven roller; a driven roller 34b which is placed opposedly to the driving roller 34a; a driving motor 35 which rotates the driving roller 33a; and a driving motor 36 which rotates the driving roller 34a.

The sheet S to be stacked on the sheet table 20 is a rectangular card in which one corner C is cut away as shown in FIG. 3A. The sheet S is stacked on the sheet table 20 while the face shown in FIG. 3A is directed upward with respect to the transportation direction. As shown in FIG. 3B, the RFID tag T is disposed on the lower face of the sheet S. In the sheet S, the face on which the RFID tag T is not disposed, i.e., the upper face shown in FIG. 3A is an image-forming face. The sheet direction detection sensor 32 detects the direction of the sheet S by detecting the cut-away corner C of the sheet.

Referring to FIG. 1, the image erasing portion 4 comprises: an erase head 40 which erases an image on the sheet S; a platen roller 41 which is placed opposedly to the erase head 40; a lifting cam 42 which lifts and lowers the erase head 40; a lifting motor 43 which rotates the lifting cam 42; a lifting position detection sensor 44 which detects the vertical position of the erase head 40; a driving roller 45a which transports the sheet S; and a driven roller 45b which is placed opposedly to the driving roller 45a.

The image forming portion 5 prints information which is transmitted from the wireless tag and received by the wireless communication medium processing portion 3, onto the sheet-like information recording medium. The image forming portion 5 has a mode in which the information is printed as it is, and that in which the information is printed after it is edited or the font or the like is changed.

The forming portion 5 comprises: a thermal head 50 which forms an image on the sheet S; a platen roller 51 which is placed opposedly to the thermal head 50; a lifting cam 52 which lifts and lowers the thermal head 50; a lifting motor 53 which rotates the lifting cam 52; a lifting position detection sensor 54 which detects the vertical position of the thermal head 50; a driving roller 55a which transports the sheet S; and a driven roller 55b which is placed opposedly to the driving roller 55a.

The recording-medium discharging portion (reading portion) 6 comprises: a holding frame 60 which holds the sheets S that are sequentially stacked from the bottom so as to be arranged in the discharged sequence from the top; two pairs of rotating members 61a, 61b which are rotated in mutually opposite directions; shafts 62a, 62b which are disposed in eccentric positions of the rotating members 61a, 61b, respectively; a driving motor 63 which rotates the rotating members 61a, 61b; driving rollers 64a, 65 which transport the sheet S; a driven roller 64b which is placed opposedly to the driving roller 64a; a driving motor 66 which rotates the driving rollers 64a, 65; and a full sensor 67 which detects that the sheets S are fully stacked in the holding frame 60.

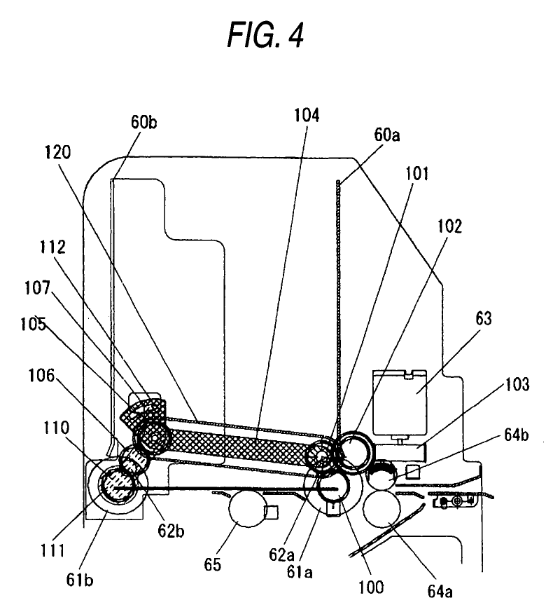

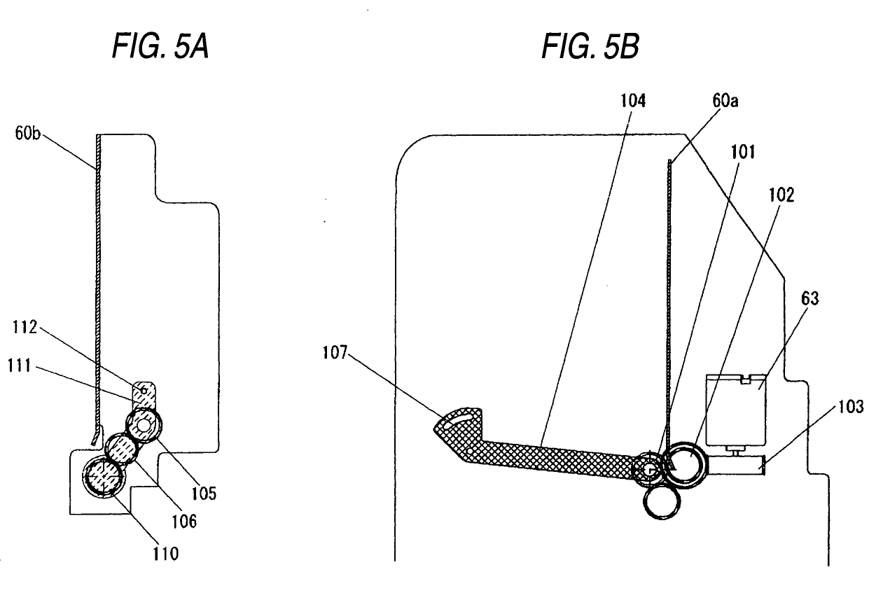

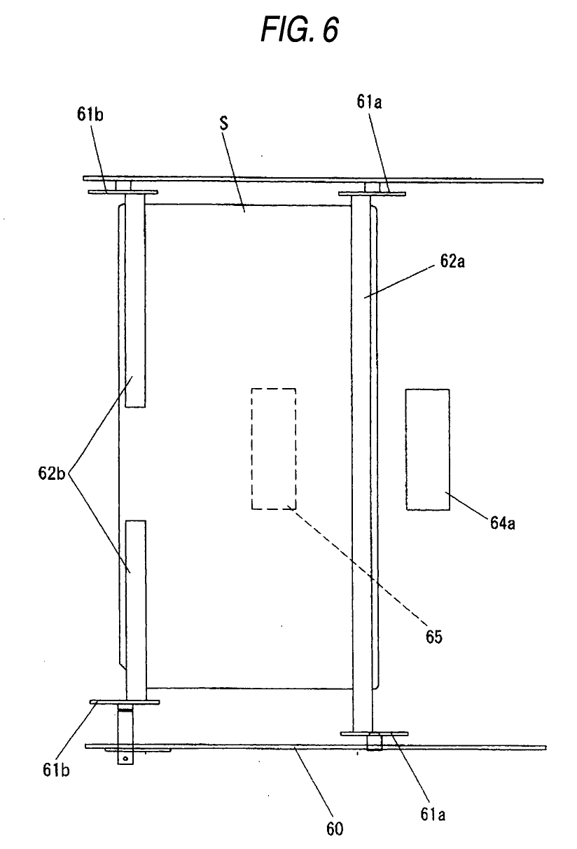

FIG. 4 is a detailed longitudinal section view of the recording-medium discharging portion 6, FIGS. 5A and 5B are longitudinal section views showing a disassembled state of the recording-medium discharging portion 6, and FIG. 6 is a plan view, partially omitted, of the recording-medium discharging portion 6.

As shown in FIGS. 4 and 5, the holding frame 60 is divided into a first frame member 60a and a second frame member 60b. With respect to the first frame member 60a which is stationary, the second frame member 60b is slidable in the lateral directions of FIG. 4. The rotating members 61a are pivotally supported on the first frame member 60a, and the rotating members 61b are pivotally supported on the second frame member 60b. When the second frame member 60b laterally slides, therefore, the distance between the rotation centers of the rotating members 61a, 61b can be changed.

Gears 100 are fixed to the rotation centers of the rotating members 61a, and gears 110 are fixed to the rotation centers of the rotating members 61b. In the recording-medium discharging portion 6, a gear 101 which rotates the rotating members 61a, gears 102, 103 which transmit the rotation of the driving motor 63 to the gear 101, and a link 104 which pivotally supports the gear 101 in one end portion are disposed. A gear 105 is pivotally supported by the other end portion of the link 104. A belt 120 which is an endless annular member is wound around the gears 101, 105. The rotation of the gear 101 is transmitted to the gear 105 via the belt 120. The rotation of the gear 105 is transmitted to the gear 110 via a reversing gear 106. The gears 105, 106, 110 are pivotally supported by a link 111. A guide hole 107 which constrains the position of a pin 112 disposed on the link 111 to a predetermined range is disposed in the link 104. As shown in FIG. 6, the rotating members 61a, 61b are disposed on the both sides of the holding frame 60. The both ends of the shaft 62a are supported by the pair of rotating members 61a. The shaft 62b is divided into two portions, and the two portions are cantilever-supported by the pair of rotating members 61b, respectively.

The rotating members 61a, 61b, the shafts 62a, 62b, the driving motor 63, the gears 100, 101, 102, 103, 105, 110, the links 104, 111, the reversing gear 106, the guide hole 107, the belt 120, and the pin 112 constitute a lifting mechanism which, during one rotation of the rotating members 61a, 61b, lifts the sheets S in the holding frame 60 from the lower side, sends the sheet S on which the image formation has been performed by the image forming portion 5, into the side under the lifted sheets S, and then lowers the lifted sheets S on the sheet S.

Returning to FIG. 1, the defective-medium discharging portion 7 comprises: a sheet holding portion 70 which holds a defective sheet S that is discharged; a transport-path switching plate 71 which switches over the transport path of the sheet S that is transported by the driving roller 55a and the driven roller 55b; and a solenoid 72 which operates the transport-path switching plate 71.

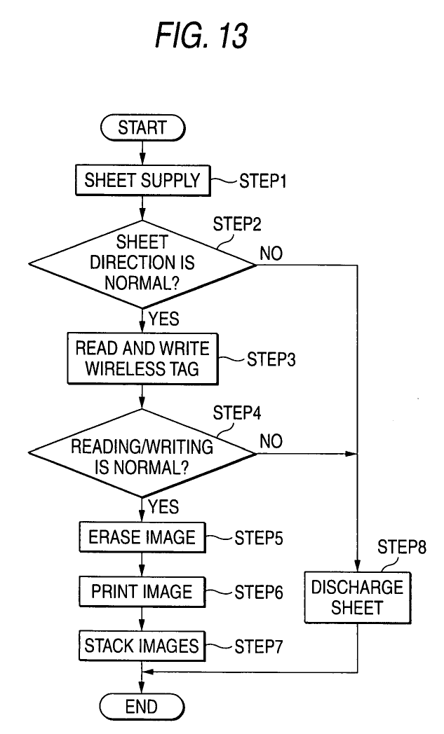

Next, the operation of the thus configured image forming apparatus 1 will be described with reference to FIGS. 1 and 13. The following operations of the portions are implemented by the controlling portion 8.

<Sheet Supplying Operation: Step 1>

First, plural sheets S are placed on the sheet table 20, and the lifting motor 23 is driven. Then, the lifting gear 21b is rotated via the gears 22a, 22b, and the sheet table 20 is lifted by the lifting rack 21a. When the sheet table 20 is lifted in this way and the uppermost sheet S on the sheet table 20 butts against the sheet intake roller 24a, the sheet intake roller unit 24 swings about the rotation support shaft 24c of the sheet intake roller 24b. When the intake roller unit position sensor 27d detects the intake position of the sheet S, the lifting motor 23 is stopped, and the operation of lifting the sheet table 20 is stopped. At this time, a driving motor (not shown) is driven, and the sheet intake rollers 24a, 24b are rotated via gears (not shown), thereby taking in the sheet S. In this case, the sheet S is in the state where the wireless tag is stuck to the upper side of the sheet.

When several sheets S are taken in from the sheet table 20, the position of the sheet intake roller 24a of the sheet intake roller unit 24 is lowered. This causes the sheet intake roller unit 24 to swing, and the unit deviates from the intake position detection of the intake roller unit position sensor 27d. Then, the lifting motor 23 is driven, and the sheet table 20 is lifted until the intake roller unit position sensor 27d detects the intake position of the sheet S. When, after these operations are repeated, the sheet table 20 is lifted and detected by the sheet table near-end sensor 27c, it is informed that a small number of sheets S remain on the sheet table 20. When the operation of taking in the sheets S is further repeated, the sheet S finally disappears, and the sheet detection sensor 27a detects that no sheet remains. Thereafter, the lifting motor 23 is driven, and the sheet table 20 is lowered until the sheet table 20 is detected by the sheet table home position sensor 27b.

<Reading/Writing Operation of Wireless Tag>

In order that, when the sheet S is taken in by rotating the sheet intake rollers 24a, 24b, another sheet(s) S is prevented from being simultaneously transported, the separation roller 25 is placed opposedly to the sheet intake rollers 24a, 24b. In order to surely prevent the simultaneous transportation, the separation roller 25 is not rotated until the load reaches a given level, and is pressed by the spring 26. In order to prevent the simultaneous transportation of sheets S from occurring, the rotation of the sheet intake rollers 24a, 24b is stopped at the same time when the sheet S from the sheet intake rollers 24a, 24b is taken in by the driving roller 33a, and the sheet S is then transported to a predetermined position by the driving roller 33a and stopped there.

<Detection of Direction of Sheet: Step 2>

During the transportation, the sheet direction detection sensor 32 (abnormality detecting portion 7A) checks the direction of the sheet S. If the sheet is directed to an adequate direction, the control proceeds to the next step. If the detection sensor 32 detects an abnormality, the control transfers to step 8.

<Reading/Writing of Wireless Tag: Step 3>

Next, the RFID control board 31 performs information reading/writing operations on the RFID tag T disposed on the sheet S, via the RFID antenna board 30. In this case, the sheet S is in the state where the wireless tag is stuck to the upper side of the sheet.

Thereafter, the driving motor 35 is driven so that the sheet S is transported by the driving roller 33a and the cleaning roller 33b. Before the sheet S is inserted between the driving roller 34a and the driven roller 34b, the driving motor 36 is driven to receive the sheet S. In this case, the peripheral speeds of the driving rollers 33a, 34a are set so as to be the driving roller 34a≧the driving roller 33a. At the same time when the sheet S is discharged from the driving roller 33a, the sheet intake roller 24a is rotated so that the next sheet S is taken in.

<Check of Reading/Writing of Wireless Tag: Step 4>

The RFID control board 31 (abnormality detecting portion 7A) checks whether information of the wireless tag on the sheet is correctly read or not, and whether information is correctly written or not. If normally performed, the control proceeds to step 5. If the abnormality detecting portion 7A detects an abnormality, the sheet which is deemed abnormal is transported to the defective-medium discharging portion 7 (step 8).

<Image Erasing Operation: Step 5>

When the tip end of the sheet S is transported under the erase head 40, the lifting motor 43 is driven in response to the erasing instruction from the controlling portion, the lifting cam 42 is rotated so that the erase head 40 drops on the sheet S, and an erasing operation is performed on the RFID tag T. Alternatively, the control may be performed so that, in place of the reading/writing operations on the wireless tag, only the erasing operation is performed. Thereafter, the erase head 40 is raised to terminate the erasing operation.

<Image Printing Operation: Step 6>

When the tip end of the sheet S is further transported under the thermal head 50, the lifting motor 53 is driven, the lifting cam 52 is rotated so that the thermal head 50 drops on the sheet S, and an image forming operation is performed.

Next, the sheet S is discharged from the driving roller 55a. After the sheet S is discharged from between the driving roller 55a and the driven roller 55b, the sheet S is taken in from the driving roller 34a.

Before the sheet S sent from the driving roller 55a is inserted between the driving roller 64a and the driven roller 64b, the driving motor 66 is driven to receive the sheet S. In this case, the peripheral speeds of the driving rollers 64a, 55a are set so as to be the driving roller 64a≧the driving roller 55a. Then, the sheet S is transported from the driving roller 64a to the driving roller 65.

<Stacking Operation: Step 7>

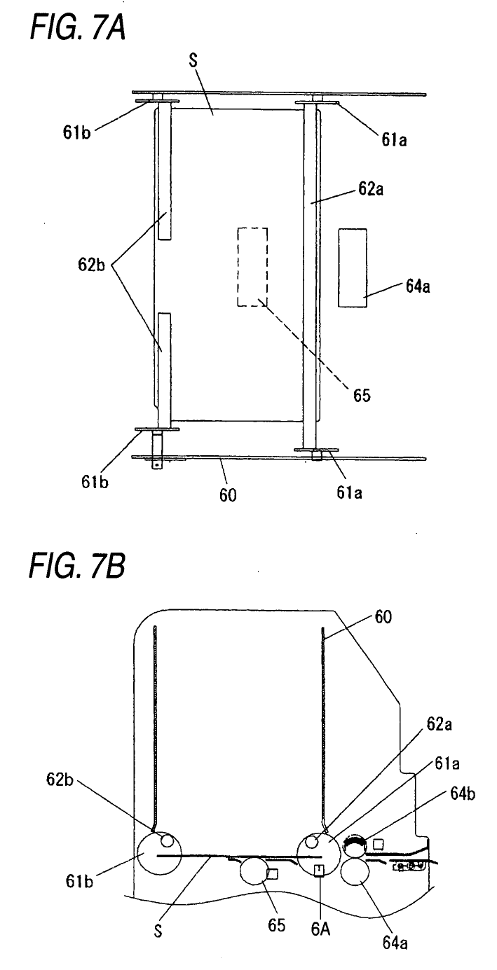

At this time, in the recording-medium discharging portion 6, the driving motor 63 is driven so that the rotating members 61a are rotated via the gears 103, 102, 101, 100, and the rotating members 61b are rotated via the belt 120, the gear 105, the reversing gear 106, and the gear 110, whereby the shafts 62a, 62b are previously raised as shown in FIG. 7A. The sheet S is then transported under the shafts 62a, 62b as shown in FIGS. 7A and 7B. When the sheet S is located at the predetermined position, this is detected by a position detecting portion 6A.

Specifically, the predetermined position where the sheet S is inserted is a position between the center of the rotation shaft of the rotating member and the lowermost point of the rotation of a projection.

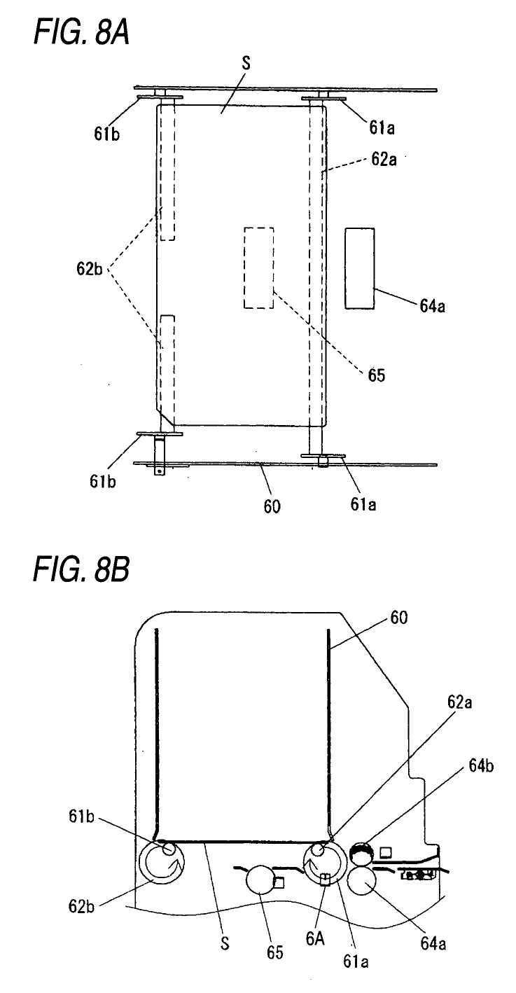

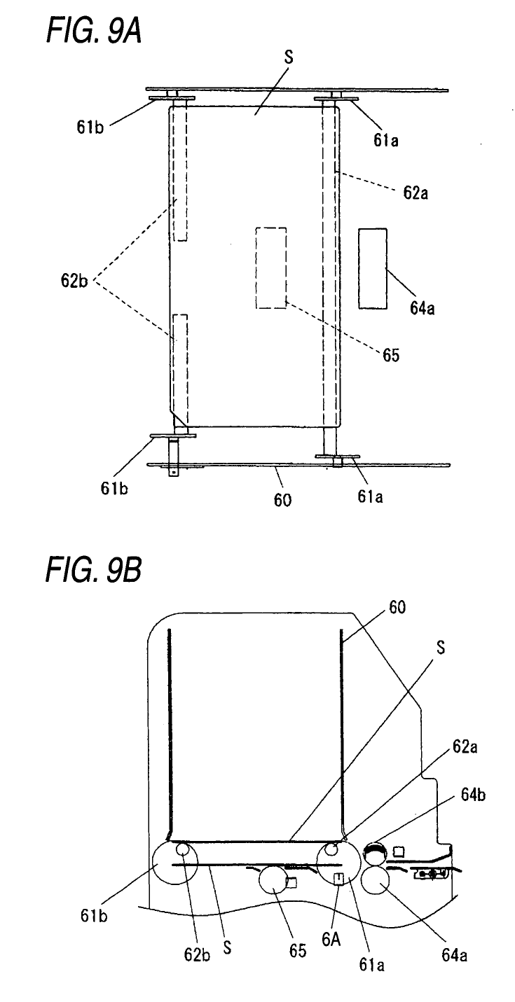

Next, in response to the detection in the position detecting portion 6A, the driving motor 63 is driven, and the rotating members 61a, 61b make one rotation in the respective outward directions, with the result that the shafts 62a, 62b are moved around to the under side of the sheet S and then raised, and the sheet S is lifted from the lower side as shown in FIGS. 8A and 8B. Thereafter, the driving rollers 64a, 65 are driven, and, as shown in FIGS. 9A and 9B, the sheet S is transported to the predetermined position which is under the shafts 62a, 62b, i.e., under the lifted sheet S.

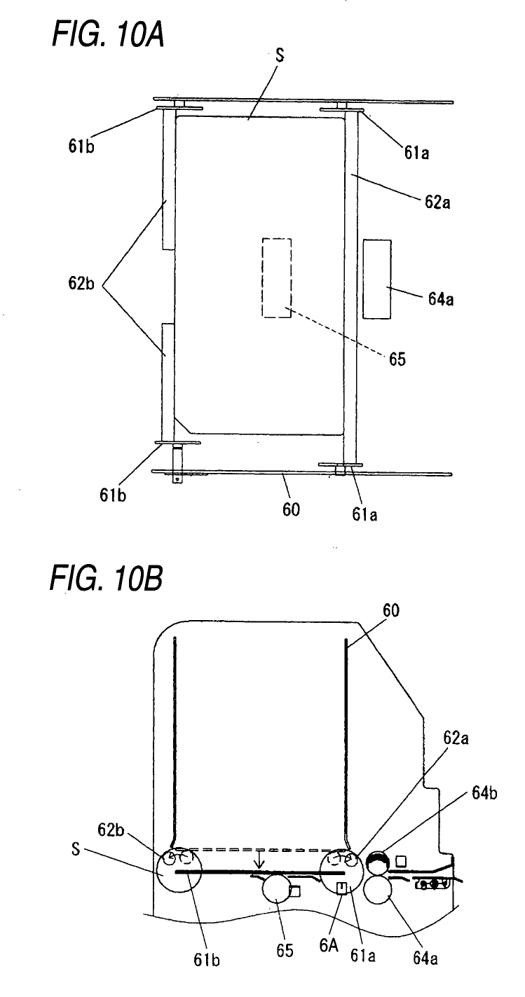

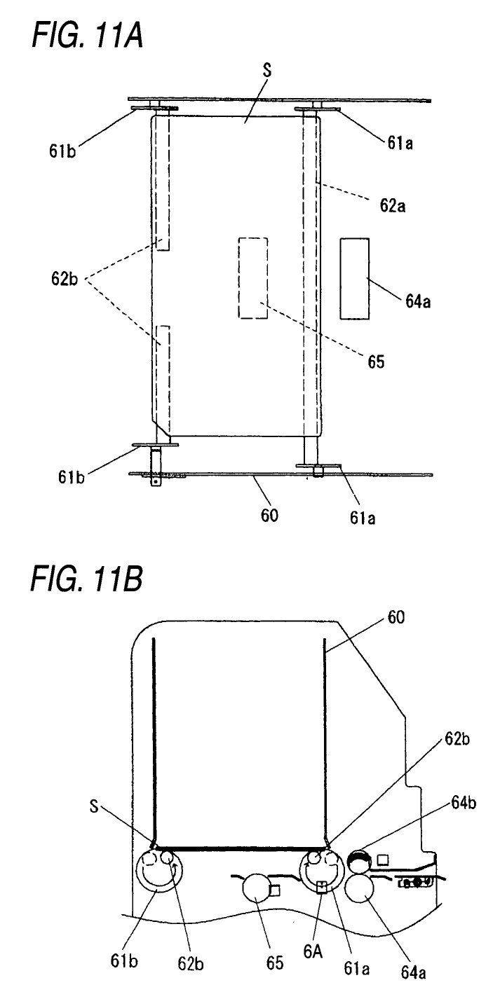

Then, in response to the detection of the sheet S in the position detecting portion 6A, the driving motor 63 is again driven, and the rotating members 61a, 61b are rotated in the respective outward directions, so that, when the distance between the shafts 62a, 62b becomes larger than the width of the sheet S as shown in FIGS. 10A and 10B, the sheet S on the shafts 62a, 62b drops to be stacked on the sheet S below. When the rotating members 61a, 61b are further rotated, the shafts 62a, 62b are moved around to the under side of the group of the stacked sheets S and then raised, and the group of the stacked sheets S is lifted from the lower side as shown in FIGS. 11A and 11B.

In the image forming apparatus 1, when these operations are repeated, the sheets sent from the sheet table 20 are sequentially stacked from the bottom in the recording-medium discharging portion 6, and the sheet S which is initially sent from the sheet table 20 is placed at the top as a result. Namely, the sheets S which are stacked at the sheet table 20 in the recording medium supplying portion 2 are sent out in turn from the top, and, when the sheet is sent to the recording-medium discharging portion 6 after the image forming operation and reaches the recording-medium discharging portion 6, the group of sheets which have already stacked in the recording-medium discharging portion 6 is lifted from the lower side, and the group of sheets are then released on the sheet disposed under the group of the sheets. Therefore, the sheets S are stacked again at the recording-medium discharging portion 6 in the state where they are sequentially stacked from the bottom. While maintaining the stacking sequence of the sheets S at the sheet table 20, consequently, the image forming operation is continuously performed, and the discharging operation is conducted.

When the sheets S are stacked to a predetermined height (maximum number of supplied sheets) in the holding frame 60, the full sensor 67 detects this, and the operations in the range from the sheet supply to the sheet discharge are stopped.

When the detection sensor 32 in the sheet supplying portion 2 detects an error of the direction of the sheet S, or when the RFID control board 31 detects a defective RFID tag T, the controlling portion 8 determines whether the sheet S is good or bad, based on such detection results. If the sheet S is determined defective as a result of the determination of the controlling portion 8, the solenoid 72 is operated to switch over the transport-path switching plate 71 so as to discharge the defective sheet S to the defective-medium discharging portion 7 which is separate from the recording-medium discharging portion 6.

According to the configuration, a sheet S which is determined that the direction is not correct, or that the RFID tag T is defective is discharged to the different place. While only the sheet S which is determined defective is removed away and the stacking sequence is maintained, the image forming operation is continuously performed, and the operation of discharging to the recording-medium discharging portion 6 is performed.

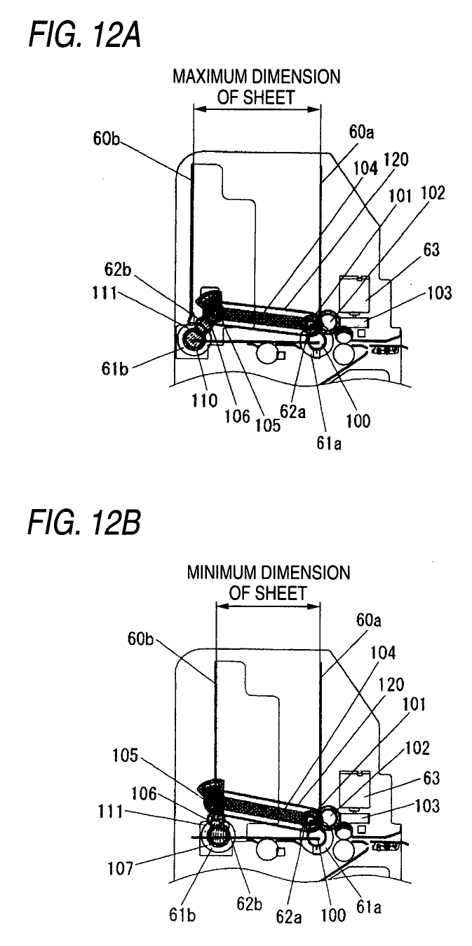

In the image forming apparatus 1 of the embodiment, even when the distance between the rotation center axes of the pair of rotating members 61a, 61b is changed, the gears 101, 105 can be synchronously rotated by the belt 129 while the distance therebetween is maintained, and the rotating members 61a, 61b can be synchronously rotated. As shown in FIGS. 12A and 12B, therefore, the frame members 60a, 60b of the holding frame 60 are laterally slid, and the distance between the rotation centers of the rotating members 61a, 61b is changed, so that the operating positions of the shafts 62a, 62b can be changed in accordance with the width of the sheet S. According to the configuration, the apparatus can cope with sheets S of various sizes.

The wireless communication medium in the invention can be applied to other media called such as a non-contact IC tag, a non-contact ID tag, and a wireless tag, in addition to the RFID tag T. Any medium may be used as far as it can perform communication in a wireless (non-contact) manner.

The embodiment is useful in the case where stacked information recording media are transported one by one and an image forming operation is continuously performed. Particularly, the embodiment is preferably used as an image forming apparatus in which an image forming operation can be continuously performed and information recording media can be discharged while maintaining the stacking sequence of the information recording media.

Many modifications and variations of the present invention are possible in the light of the above techniques. It is therefore to be understood that within the scope of the invention the invention may be practiced otherwise than as specifically described.

What is claimed is:

1. An image forming apparatus comprising:
a supplying portion that stacks sheet-like information recording media each having a wireless tag, and sequentially supply the stacked information recording media from a top thereof;
a reading portion that reads information stored in the wireless tag of the information recording medium supplied from the supplying portion;
an image erasing portion that erases an image on the information recording medium sent from the reading portion;
an image forming portion that forms an image on the information recording medium sent from the erasing portion; and
a stacking portion that stacks the information recording medium on which the image is formed from a bottom in a sequence at which the information recording media are sent from the image forming portion.

2. The image forming apparatus according to claim 1 further comprising a detecting portion which detects that the information recording media is located at a predetermined position, and a controlling portion for starting the stacking operation in response to the detection of the information recording media in the detecting portion.

3. The image forming apparatus according to claim 1 further comprising a transporting portion that moves the information recording medium to a predetermined stacking position of the stacking portion through a path that extends substantially horizontally from the supplying portion to the reading portion, the image erasing portion, the image forming portion, and the stacking portion.

4. The image forming apparatus according to claim 1, wherein the image forming portion forms the image on the information recording medium based on information read from the wireless tag by the reading portion.

5. The image forming apparatus according to claim 1, wherein the supplying portion supplies the stacked information recording media in a state where the wireless tag is stuck to an upper side of the medium.

6. The image forming apparatus according to claim 1, wherein the stacking portion includes a lifting mechanism which lifts plural stacked information recording media from a lower side, sends the information recording medium, on which the image is formed by the image forming portion, below the lifted plural information recording media, and then lowers the lifted information recording media on the information recording medium.

7. The image forming apparatus according to claim 1 further comprising:
a detecting portion that determines whether the information recording medium is good or bad; and
a discharging portion that discharges the information recording medium that is determined defective by the detecting portion, between the determining portion and the stacking portion.

8. A sheet stacking apparatus for stacking sheets, comprising:
two rotating members that rotate in different directions about rotation axes that horizontally extend in parallel to each other, respectively, wherein while the two rotating members rotate, levels of the projections are substantially identical with each other, and a distance between the rotating members is set so that a distance between the projections becomes larger and smaller than a width of the sheet;
a projection that is projectingly disposed on a side face of each of the rotating members, and with being separated from the rotation axis of the rotating member;
a sheet inserting portion that inserts each of the sheets;
a driving portion that rotates the rotating members about the rotation axes; and
a controlling portion that performs controlling in such a manner that:
after the sheet is inserted by the sheet inserting portion to a predetermined position under the projections, the rotating members are rotated in directions in which the projections push up the sheet from a lower side in a state where the distance between the projections is smaller than the width of the sheet,
when the projections reach a predetermined level, a following sheet is subsequently inserted by the sheet inserting portion to the predetermined position under the projections, and
the rotating members are further rotated to attain a state where the distance between the projections is larger than the width of the sheet, thereby causing the sheet to be stacked on the subsequently inserted following sheet.

9. The sheet stacking apparatus according to claim 8 further comprising a detecting portion that detects that the sheet is located at a predetermined position, and a controlling portion for starting the stacking operation in response to the detection of the sheet in the detecting portion.

10. The sheet stacking apparatus according to claim 8, wherein the predetermined position to which the sheet is inserted by the sheet inserting portion under the projections is a position between a center of the rotation axis of the rotating member and a lowermost point of the rotation of the projection.

11. The sheet stacking apparatus according to claim 8 further comprising an adjusting portion which adjusts the distance between the rotating members.

12. A method of stacking sheets using a sheet stacking apparatus comprises: two rotating members that rotate in different directions about rotation axes that horizontally extend in parallel to each other, respectively, wherein while the two rotating members rotate, levels of the projections are substantially identical with each other, and a distance between the rotating members is set so that a distance between the projections becomes larger and smaller than a width of the sheet; a projection that is projectingly disposed on a side face of each of the rotating members, and with being separated from the rotation axis of the rotating member; a sheet inserting portion that inserts each of the sheets; and a driving portion that rotates the rotating members about the rotation axes, the method comprising the steps of:
(i) after the sheet is inserted by the sheet inserting portion to a predetermined position under the projections, rotating the rotating members in directions in which the projections push up the sheet from a lower side in a state where the distance between the projections is smaller than the width of the sheet,
(ii) when the projections reach a predetermined level, subsequently inserting a following sheet by the sheet inserting portion to the predetermined position under the projections, and
(iii) further rotating the rotating members to attain a state where the distance between the projections is larger than the width of the sheet, thereby causing the sheet to be stacked on the subsequently inserted following sheet.
